(19) United States
(12) Patent Application Publication
(10) Pub. No.: US 2014/0295041 A1
(43) Pub. Date: Oct. 2, 2014

(54) Composition

(71) Applicant: NATURAL BIOTECHNOLOGY SPRL, Courcelles (BE)

(72) Inventor: Jeffrey Dodd, Lancashire (GB)

(21) Appl. No.: 14/346,676

(22) PCT Filed: Sep. 21, 2012
(86) PCT No.: PCT/GB2012/000739

§ 371 Date: Mar. 21, 2014

(30) Foreign Application Priority Data
Sep. 23, 2011 (GB) 1116433.2
Aug. 3, 2012 (GB) 1215482.9

(51) Int. Cl. A23L 3/349; A23L 1/39; A23L 2/44

(52) U.S. Cl. CPC A23L 3/349; A23L 2/44; A23L 1/39
USPC 426/330.3; 426/532; 426/330

(57) ABSTRACT

There is described a preservative composition for sterilizing beverages and/or sauces, said preservative composition comprising a preservative effective amount of one or more of: an antioxidant; an acidulant; an antimicrobial agent; a clarifying agent; and a firming agent.

### FIELD OF THE INVENTION

The present invention relates to a novel composition and to novel methods related thereto.

More particularly, the invention relates a novel composition suitable for the preservation of beverages and sauces; a method for sterilizing and preserving a beverage or sauce; and a beverage or sauce comprising such a preservative composition.

### BACKGROUND OF THE INVENTION

Certain drinks or beverages may be preserved by pasteurization, hot-filling or aseptic filling.

However, the cold-fill of beverages, such as wines, carbonated soft drinks, juices, juice sparklers, cocktail mixes, syrups, concentrates, sports drinks, flavoured waters and ready to drink teas may be achieved by the use of a microbial control agent, such as, dimethyldicarbonate (DMDC) (E242), which acts by inhibiting the enzymes acetate kinase and L-glutamic acid decarboxylase.

DMDC is effective at eliminating spoilage micro-organisms (yeast, bacteria and mould) and increasing the shelf-life of beverages without affecting the taste, colour, and aroma of the beverage. An advantage of using DMDC is that it hydrolyses when in contact with water, producing methanol and carbon dioxide and so it is not present when the consumer opens the container. However, for example, in the UK the FSA (Food Standards Agency) advise that it is nevertheless included in the ingredients list on the beverage label.

Although DMDC is considered to be safe as a food additive, it is nonetheless a highly flammable colourless liquid and is a skin and eye irritant. Sometimes allergic reactions are encountered and its toxicology has not been fully investigated.

Therefore, there is a need for a “natural” preservative suitable for use with a beverage or a sauce.

### SUMMARY OF THE INVENTION

We have now found a novel preservative composition for sterilizing beverages and/or sauces. In particular, the composition of the invention is suitable for inhibiting the formation and/or growth of mould and/or fungi beverages and/or sauces.

Therefore, according to a first aspect of the invention there is provided a preservative composition for sterilizing beverages and/or sauces, said preservative composition comprising a preservative effective amount of one or more of:
an antioxidant;
an acidulant;
an antimicrobial agent;
a clarifying agent; and
a firming agent.

Preferably, the preservative composition of the invention comprises at least two agents selected from the group consisting of an antioxidant; an acidulant; an antimicrobial agent; a clarifying agent; and a firming agent.

Preferably, the preservative composition of the invention comprises at least three agents selected from the group consisting of an antioxidant; an acidulant; an antimicrobial agent; a clarifying agent; and a firming agent.

Preferably, the preservative composition of the invention comprises at least four agents selected from the group consisting of an antioxidant; an acidulant; an antimicrobial agent; a clarifying agent; and a firming agent.

More preferably, the preservative composition of the invention comprises an antioxidant; an acidulant; an antimicrobial agent; a clarifying agent; and a firming agent.

A variety of antioxidants reducing agents or may be used which are known to the person skilled in the art, such as ascorbic acid, erythorbic acid, kojic acid, and salts thereof. A preferred reducing agent or antioxidant is ascorbic acid, and salts thereof. Thus, the composition may comprise the use of an antioxidant selected from one or more of ascorbic acid, erythorbic acid and kojic acid; and salts thereof. ascorbic acid, or a salt thereof, is an antioxidant and reducing agent which functions as a free radical scavenger preventing oxidation by altering the REDOX potential of the system and reduces undesirable oxidative products. Ascorbic acid acts as an antioxidant in that oxygen preferentially reacts with the ascorbic acid. Salts of ascorbic acid, may include, but shall not be limited to, alkali metal salts, e.g. sodium ascorbate, and alkaline earth metal salts, e.g. calcium ascorbate.

The amount of the antioxidant, e.g. ascorbic acid, or a salt thereof, in the composition of the invention may vary and may be from about 0.05% w/w to about 10% w/w, preferably from about 0.1% w/w to about 5% w/w.

In one aspect of the invention the acidulant may be an acidified salt, such as, acidified sodium chloride, e.g. sodium hydrogen sulphate (NaHSO₄). The modified acidified salt may be a mixture of sodium hydrogen sulphate as hereinbefore described and a natural organic acid such as lactic acid or citric acid, or a salt thereof, or mixtures thereof. The natural organic acid, or a salt thereof, when present, may comprise from about 0.1 to 2.% w/w of the acidulant. The acidulant may have an inhibitory effect on phenolase, for example, by reducing the pH to below the level at which is required to inactivate phenolase. The optimum pH of phenolase activity varies with the source of the enzyme and the particular substrate, e.g. fruit juice, vegetable juice, etc., but generally phenolase has an optimum activity at a pH of from 6 to 7. Therefore, according to this aspect of the invention the acidulant is selected from those that will reduce the pH to below 4 In an especially preferred aspect of the invention the acidulant will reduce the pH to about 3. In an especially preferred aspect of the invention the acidulant will reduce the pH to about 2.84.

A variety of antimicrobial agents may be used which may act as a preservative to prevent the growth of moulds, yeast and/or fungi. Such antimicrobial agents include, but shall not be limited to, sorbic acid (2,4-hexadienoic acid), or a salt thereof. Suitable salts include sodium sorbate, potassium sorbate, calcium sorbate, etc.

The amount of the antimicrobial agent, e.g. sorbic acid, or a salt thereof, in the composition of the invention may vary and may be from about 0.05% w/w to about 10% w/w, preferably from about 0.1% w/w to about 5% w/w.

A variety of clarifying agents may be used. Such a clarifying agent is advantageously also an acidulant which may also reduce the pH of the environment. Examples of such a clarifying agent are organic chelating acids, such as, tannic acid, or a derivative thereof. Optionally, the clarifying agent may comprise a combination of tannic acid, or a derivative thereof and another organic acid, such as citric acid, or a salt thereof.

The firming agent preferably comprises a source of calcium ions. Thus, the calcium ions may be in the form of one or more of, e.g. in the form of one or more of the group consisting of calcium chloride, e.g. calcium chloride dehydrate, calcium hydroxide, calcium carbonate, calcium phosphate, calcium erythorbate, calcium acetate, calcium gluconate, calcium glycerophosphate, calcium lactate, calcium ascorbate and mixtures thereof. Preferably, the calcium ions are in the form of calcium chloride, e.g. calcium chloride dehydrate. the composition of the present invention comprises from about 0.05% w/w to about 90% w/w calcium chloride from about 0.05% w/w to about 80%w/w calcium chloride from about 0.05% w/w to about 70% w/w calcium chloride from about 0.05% w/w to about 60% w/w calcium chloride from about 0.05% w/w to about 50% w/w calcium chloride from about 0.05% w/w to about 40% w/w calcium chloride from about 0.05% w/w to about 30% w/w calcium chloride from about 0.05% w/w to about 20% w/w calcium chloride from about 0.05% w/w to about 10% w/w calcium chloride from about 0.05% w/w to about 5% w/w calcium chloride from about 0.05% w/w to about 1% w/w calcium chloride most preferably from about 0.05% w/w to about 0.4% w/w calcium chloride.

The composition of the invention may be provided in solid or liquid form, i.e. as an aqueous solution.

In addition, the preservative composition of the invention may include trace amounts of one or more of an alkanol and/or an alkanoic acid, or a salt thereof, such as formic acid (methanoic acid), and/or acetic acid (ethanoic acid).

According to a preferred aspect of the invention there is especially provided a preservative composition for sterilizing beverages and/or sauces, said preservative composition comprising a preservative effective amount of one or more of:
sorbic acid, or a salt thereof;
calcium chloride;
ascorbic acid, or a salt thereof;
citric acid, or a salt thereof;
tannic acid, or a salt thereof;
sodium hydrogen sulphate; and/or
lactic acid, or a salt thereof.

Preferably, the method for sterilizing and preserving a beverage or sauce comprising incorporating into said beverage or sauce a preservative effective amount of a preservative comprising:
sorbic acid, or a salt thereof;
calcium chloride;
ascorbic acid, or a salt thereof;
citric acid, or a salt thereof;
tannic acid, or a salt thereof;
sodium hydrogen sulphate; and
lactic acid, or a salt thereof.

The term “preservative” will generally be understood by the person skilled in the art, and shall mean the elimination or inhibition of micro-organisms (yeast, fungi, bacteria and mould) and anti-browning.

The invention further provides a method for sterilizing and preserving a beverage or sauce comprising incorporating into said beverage or sauce a preservative effective amount of a preservative comprising one or more of:
an antioxidant;
an acidulant;
an antimicrobial agent;
a clarifying agent; and
a firming agent.

Preferably, the method of the invention comprises at least two agents selected from the group consisting of an antioxidant; an acidulant; an antimicrobial agent; a clarifying agent; and a firming agent.

Preferably, the method of the invention comprises at least three agents selected from the group consisting of an antioxidant; an acidulant; an antimicrobial agent; a clarifying agent; and a firming agent.

Preferably, the method of the invention comprises at least four agents selected from the group consisting of an antioxidant; an acidulant; an antimicrobial agent; a clarifying agent; and a firming agent.

More preferably, the method of the invention comprises an antioxidant; an acidulant; an antimicrobial agent; a clarifying agent; and a firming agent.

According to this aspect of the invention there is especially provided a method for sterilizing and preserving a beverage or sauce comprising incorporating into said beverage or sauce a preservative effective amount of a preservative comprising one or more of:
sorbic acid, or a salt thereof;
calcium chloride;
ascorbic acid, or a salt thereof;
citric acid, or a salt thereof,
tannic acid, or a salt thereof;
sodium hydrogen sulphate; and/or
lactic acid, or a salt thereof.

Preferably, the method for sterilizing and preserving a beverage or sauce comprising incorporating into said beverage or sauce a preservative effective amount of a preservative comprising:
sorbic acid, or a salt thereof;
calcium chloride;
ascorbic acid, or a salt thereof;
citric acid, or a salt thereof;
tannic acid, or a salt thereof;
sodium hydrogen sulphate; and
lactic acid, or a salt thereof.

The invention further provides a beverage comprising a preservative effective amount of a preservative composition as hereinbefore described.

As used herein there term “beverage” or “beverages” may mean, but shall not be limited to, one or more of wines, carbonated soft drink, juice, juice sparkler, cocktail mix, syrup, concentrate, sports drink, flavoured water and ready to drink tea, etc.

The invention further provides a sauce comprising a preservative effective amount of a preservative composition as hereinbefore described.

As used herein there term “sauce” or “sauces” may mean, but shall not be limited to, one or more of a puree, dip, e.g. a salad dip, mayonnaise, ketchup, etc.

The term “salts” shall, unless otherwise stated, include, for example, alkali metal salts, e.g. sodium, potassium, etc, and combinations thereof. Thus, a preferred salt of sorbic acid is potassium sorbate and/or calcium sorbate.

The invention will now be described by way of example only.

### EXAMPLE 1

### RD ABFL 300

1. Sorbic Acid, Potassium Sorbate, Calcium Sorbate
2. Calcium Chloride
3. Ascorbic Acid
4. Citric Acid
5. Tannic Acid
6. Sodium Hydrogen Sulphate
7. Lactic Acid

1. A preservative composition for sterilizing beverages and/or sauces, said preservative composition comprising a preservative effective amount of one or more of:
an antioxidant;
an acidulant;
an antimicrobial agent;
a clarifying agent; and
a firming agent.

2. A preservative composition according to claim 1 wherein the preservative composition comprises at least two agents selected from the group consisting of an antioxidant; an acidulant; an antimicrobial agent; a clarifying agent; and a firming agent.

3.-4. (canceled)

5. A preservative composition according to claim 1 wherein the preservative composition comprises an antioxidant; an acidulant; an antimicrobial agent; a clarifying agent; and a firming agent.

6. A preservative composition according to claim 1 wherein the antioxidant is ascorbic acid, erythorbic acid, or a salt thereof.

7. A preservative composition according to claim 6 wherein the ascorbic acid is present as calcium ascorbate.

8. (canceled)

9. A preservative composition according to claim 1 wherein the acidulant is an acidified salt.

10.-11. (canceled)

12. A preservative composition according to claim 1 wherein the acidulant includes a natural organic acid.

13.-14. (canceled)

15. A preservative composition according to claim 1 wherein the antimicrobial agents is sorbic acid (2,4-hexadienoic acid), or a salt thereof.

16.-17. (canceled)

18. A preservative composition according to claim 1 wherein the clarifying agent is an organic chelating acid.

19. A preservative composition according to claim 18 wherein the organic chelating acid is tannic acid, or a derivative thereof.

20.-21. (canceled)

22. A preservative composition according to claim 1 wherein the firming agent comprises a source of calcium ions.

23.-25. (canceled)

26. A preservative composition according to claim 1 wherein the composition is in liquid form.

27. (canceled)

28. A preservative composition according to claim 1 wherein the composition is in solid form.

29.-31. (canceled)

32. A preservative composition according to claim 1 comprising a preservative effective amount of one or more of:
sorbic acid, or a salt thereof;
calcium chloride;
ascorbic acid, or a salt thereof;
citric acid, or a salt thereof;
tannic acid, or a salt thereof;
sodium hydrogen sulphate; and/or
lactic acid, or a salt thereof.

33. A method for sterilizing and preserving a beverage or sauce comprising incorporating into said beverage or sauce a preservative effective amount of a preservative comprising one or more of:
an antioxidant;
an acidulant;
an antimicrobial agent;
a clarifying agent; and
a firming agent.

34. A method according to claim 33 comprising one or more of:
sorbic acid, or a salt thereof;
calcium chloride;
ascorbic acid, or a salt thereof;
citric acid, or a salt thereof;
tannic acid, or a salt thereof;
sodium hydrogen sulphate; and
lactic acid, or a salt thereof.

35. A beverage comprising a preservative effective amount of a preservative comprising one or more of:
an antioxidant;
an acidulant;
an antimicrobial agent;
a clarifying agent; and
a firming agent.

36. A beverage according to claim 35 comprising one or more of:
sorbic acid, or a salt thereof;
calcium chloride;
ascorbic acid, or a salt thereof;
citric acid, or a salt thereof;
tannic acid, or a salt thereof;
sodium hydrogen sulphate; and
lactic acid, or a salt thereof.

37. (canceled)

38. A sauce comprising a preservative effective amount of a preservative comprising one or more of:
an antioxidant;
an acidulant;
an antimicrobial agent;
a clarifying agent; and
a firming agent.

39. A sauce according to claim 38 comprising one or more of:
sorbic acid, or a salt thereof;
calcium chloride;
ascorbic acid, or a salt thereof;
citric acid, or a salt thereof;
tannic acid, or a salt thereof;
sodium hydrogen sulphate; and
lactic acid, or a salt thereof.

40.-41. (canceled)
